(19) United States
(12) Patent Application Publication
(10) Pub. No.: US 2025/0364728 A1
(43) Pub. Date: Nov. 27, 2025

(54) ANTENNA ASSEMBLY WITH DIRECTIVE ANTENNA FOR USE IN A COMMUNICATION DEVICE

(71) Applicant: Thomson Licensing, Cesson-Sevigne (FR)

(72) Inventors: Dominique LO HINE TONG, Rennes (FR); Philippe MINARD, Saint Medard sur ille (FR)

(21) Appl. No.: 18/874,601

(22) PCT Filed: Feb. 24, 2023
(86) PCT No.: PCT/EP2023/054750

§ 371 Date: Dec. 13, 2024

(30) Foreign Application Priority Data
Jun. 21, 2022 (FR) FR2206091

(51) Int. Cl. H01Q 19/18; H01Q 1/22; H01Q 9/28; H01Q 15/24

(52) U.S. Cl. CPC H01Q 19/18; H01Q 1/2291; H01Q 9/28; H01Q 15/24

(57) ABSTRACT

An apparatus and accompanying antenna assembly is described. The apparatus includes a circuit that processes a communication signal received and/or transmitted wirelessly over a network and an antenna assembly. The antenna assembly includes a printed circuit board having a set of conductive elements forming an antenna structure on at least one of a top surface and a bottom surface of the printed circuit board, the printed circuit board further including one or more additional conductive elements at least partially surrounding the antenna structure. The antenna assembly further includes a conductive plate positioned parallel to the bottom surface of the printed circuit board, the conductive plate supporting the printed circuit board at a fixed distance from the conductive plate using one or more conductive mechanical support elements. The one or more additional conductive elements are coupled to the conductive plate through the one or more conductive mechanical support elements.

### TECHNICAL FIELD

The present disclosure generally relates to an antenna assembly and, more specifically, to an antenna assembly including a reflector that is used as part of an electronic assembly in an apparatus, such as a communication device.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Wireless communication networks are present in many communication systems today. Many of the communication devices used in these systems include a plurality of antennas for interfacing to multiple networks. These communication devices often include, but are not limited to, set-top boxes, gateways, cellular or wireless telephones, televisions, home computers, media content players, and the like. Further, many of these communication devices may include multiple interfaces for the different types of networks. As a result, one or more antennas may be present on or inside the structure of the communication device.

Many of these communication devices continue to be reduced in size. As a result, any antennas, or antenna assemblies, that are located inside the structure of the communication devices required to fit into smaller areas. The problem is further complicated in communication devices that have to embed a plurality of antennas inside the structure in order to wirelessly operate over a plurality of wide area networks (WANs) as well as local area networks (LANs). Such requirements often lead to drastic integration issues due to limited space and the need to minimize interference between the antennas during operation. Compact antenna designs and assemblies are necessary to meet the requirements.

Newer and more complex wireless WANs are also becoming prevalent at customer premises or homes, These WANs feature delivery of high speed internet access that is similar to performance from more traditional wired networks. In order to achieve this performance level, many of these WANs require more complex, higher gain antennas in order to assure a minimum user performance level when used indoors at the home. For instance, in cellular fifth generation (5G) indoor fixed wireless access (FWA) applications, the antennas must have an antenna gain approaching 10 decibels (dB) to achieve the required link budget with the 5G base station.

In many antenna designs, the antenna gain and corresponding antenna directivity performance for the antenna radiating elements can be improved by including a reflecting element or reflector surface positioned at a fixed distance from one or more of the radiating elements. In many instances, the larger the area of the reflector, the higher the antenna gain and directivity. However, the ability to increase the size of the reflector and/or the distance from the antenna radiating element(s) may be limited by the space limitations of the structure of the communication device as described above. The requirement to increase the antenna gain of the antenna can be in conflict with the space allocated for the antenna assembly. Therefore, there is a need for an improved antenna assembly that provides high antenna gain performance in a compact size for use within a communication device.

### SUMMARY

These and other drawbacks and disadvantages presented by antenna assemblies for use in communication devices are addressed by the principles of the present disclosure. However, it can be understood by those skilled in the art that the present principles may offer advantages in other types of devices and systems as well.

According to an implementation, an antenna assembly is described. The antenna assembly includes a printed circuit board having a set of conductive elements forming an antenna structure on at least one of a top surface and a bottom surface of the printed circuit board, the printed circuit board further including at least one additional conductive element at least partially surrounding the antenna structure. The antenna assembly further includes a conductive plate positioned parallel to the bottom surface of the printed circuit board, the conductive plate supporting the printed circuit board at a fixed distance from the conductive plate using at least one conductive mechanical support element. The at least one additional conductive element is coupled to the conductive plate through the at least one conductive mechanical support element.

According to an implementation, an apparatus is described. The apparatus includes a circuit capable of at least one of processing a communication signal received wirelessly from a network and processing a communication signal for transmission wirelessly to the network. The apparatus further includes an antenna assembly coupled to the circuit. The antenna assembly includes a printed circuit board having a set of conductive elements forming an antenna structure on at least one of a top surface and a bottom surface of the printed circuit board, the printed circuit board further including at least one additional conductive element at least partially surrounding the antenna structure. The antenna assembly further includes a conductive plate positioned parallel to the bottom surface of the printed circuit board, the conductive plate supporting the printed circuit board at a fixed distance from the conductive plate using at least one conductive mechanical support element. The at least one additional conductive element is coupled to the conductive plate through the at least one conductive mechanical support element.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a block diagram of an exemplary communication device to which the principles of the present disclosure are applicable;

FIG. 2 is a block diagram of an exemplary gateway device to which the principles of the present disclosure are applicable

FIG. 3A and 3B are two perspective views of an exemplary electronic assembly including a plurality of integrated antennas and antenna assemblies used in a gateway device to which the principles of the present disclosure are applicable

FIG. 4 is a diagram of an exemplary antenna assembly to which the principles of the present disclosure are applicable;

FIGS. 5A and 5B are graphs illustrating a set of characteristics of an exemplary antenna assembly and a similar exemplary antenna to which the principles of the present disclosure are applicable respectively;

FIGS. 6A and 6B are graphs illustrating another set of characteristics of an exemplary antenna assembly and a similar exemplary antenna to which the principles of the present disclosure are applicable respectively;

FIGS. 7A and 7B are graphs illustrating a further set of characteristics of an exemplary antenna assembly and a similar exemplary antenna to which the principles of the present disclosure are applicable respectively;

FIGS. 8A and 8A are graphs illustrating yet another set of characteristics of an exemplary antenna assembly and a similar exemplary antenna to which the principles of the present disclosure are applicable respectively;

FIG. 9 is a diagram of another exemplary antenna assembly to which the principles of the present disclosure are applicable;

FIG. 10 is a diagram of a further exemplary antenna assembly to which the principles of the present disclosure are applicable;

FIG. 11 is a diagram of yet another exemplary antenna assembly to which the principles of the present disclosure are applicable;

FIG. 12 is a diagram of still a further exemplary antenna assembly to which the principles of the present disclosure are applicable;

FIG. 13 is a diagram of yet another exemplary antenna assembly to which the principles of the present disclosure are applicable; and

FIG. 14 is a diagram of still a further exemplary antenna assembly to which the principles of the present disclosure are applicable.

### DETAILED DESCRIPTION

The present disclosure may be applicable to electronic apparatuses or devices described as being assembled apparatuses or devices having one or more integrated antenna assemblies. The present disclosure further addresses manufacturing and assembly issues associated with the use of one or more of the various available integrated antenna assemblies that may be used in electronic apparatuses or devices.

The present description illustrates the principles of the present disclosure. It will thus be appreciated that those skilled in the art will be able to devise various arrangements which, although not explicitly described or shown herein, embody the principles of the present disclosure and are included within the scope of the claims.

All examples and conditional language recited herein are intended for pedagogical purposes to aid the reader in understanding the principles of the present disclosure and the concepts contributed by the inventor(s) to furthering the art and are to be construed as being without limitation to such specifically recited examples and conditions.

Moreover, all statements herein reciting principles and aspects of the present disclosure, as well as specific embodiments and examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the embodiments hereof, any element expressed or described, directly or indirectly, as a means for performing a specified function is intended to encompass any way of performing that function including, for example, a) a combination of elements that performs that function or b) any mechanism having a combination of electrical or mechanical elements to perform that function. The disclosure as defined by such claims resides in the fact that the functionalities provided by the various recited means are combined and brought together in the manner which the claims call for. It is thus regarded that any means that can provide those functionalities are equivalent to those shown herein.

The present embodiments address problems associated with increasing the performance, and in particular, the gain and/or directivity, of an antenna structure or assembly while still maintaining the mechanical compactness and ease of manufacturing required of customer premises equipment (CPEs), such as gateway devices, and other similar communication devices. The increase in performance may be necessitated by the need to improve the link performance of a network connection or may be due to the presence of additional network interfaces and antenna structures that are included in an already limited area within the CPEs and communication devices. In many cases, the need to improve the performance of an antenna structure or assembly requires additional elements, often referred to collectively as parasitic elements, that increase antenna gain and directivity. However, achieving improved performance and simultaneously meeting the mechanical compactness requirement and ease of manufacturing requirements for the CPE or communication device design is often very difficult.

The present disclosure addresses these problems by taking advantage of characteristics associated with the use of additional conductive elements positioned near the radiating elements of an antenna structure on the printed circuit board that includes the radiating elements. The additional conductive elements are electrically connected to a conductive plate configured as a reflector having approximately the same size as the printed circuit board and positioned a small distance from the printed circuit board. Additionally, the electrical connection is achieved using conductive elements used to mechanically attach to and support the printed circuit board from the conductive plate. The additional conductive elements increase the operational performance, and in particular, the antenna gain and directivity of the antenna assembly over the performance of the antenna assembly with only conductive plate configured as a reflector. Further, by integrating the additional conductive elements as part of the printed circuit board assembly that includes the radiating element of the antenna structure, a low cost, compact, and easy to manufacture solution to the problem is realized.

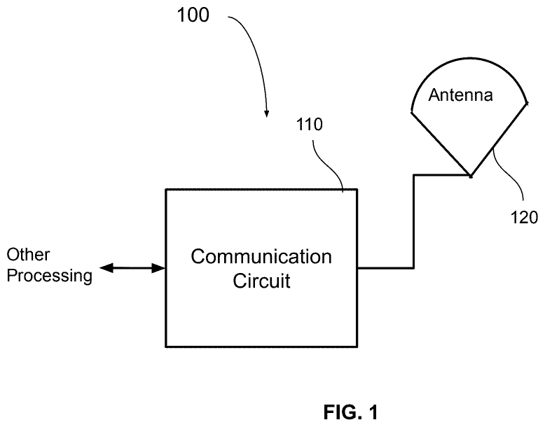

Turning to FIG. 1, a block diagram of an embodiment of a communication device 100 according to aspects of the present disclosure is shown. Communication device 100 may be used as part of a communication receiver, transmitter, and/or transceiver device including, but not limited to, a handheld radio, a set-top box, a gateway, a modem, a router, a cellular or wireless telephone, a cellular or wireless outdoor unit, a television, a home computer, a tablet, and a media content player. Communication device 100 may include one or more interfaces to wireless networks including, but not limited to, third generation (3G), LTE, or fifth generation (5G) cellular, Institute of Electrical and Electronics Engineers (IEEE) standard 802.11, Wi-Fi, or other similar wireless communication protocols. It is important to note that several components and interconnections necessary for complete operation of communication device 100, either as a standalone device or incorporated as part of another device, are not shown in the interest of conciseness, as the components not shown are well known to those skilled in the art.

Communication device 100 includes a communication circuit 110 that interfaces with other processing circuits, such as a processor, memory, and user interface, not shown. Communication circuit 110 connects to antenna 120. Antenna 120 provides the interface to the airwaves for transmission and reception of signals to and from communication device 100.

Communication circuit 110 includes circuitry for performing signal transmission and reception of a signal interfaced through antenna 120 to another device over a wireless network. A received signal from antenna 120 may be processed by a low noise amplifier and tuned by a set of filters, mixers, and oscillators included in communication circuit 110. The tuned signal may be digitized and further demodulated and decoded. The decoded signal may be provided to other processing circuits. Additionally, communication circuit 110 generates, converts, and/or formats an input signal (e.g., an audio, video, or data signal) from the other processing circuits for transmission through antenna 120. Communication circuit 110 may include a power amplifier for increasing the transmitted signal level of the signal sent from communication device 100 over the wireless network. Adjustment of the amplification applied to a signal received from antenna 120 as well as amplification for a signal transmitted by antenna 120 may be controlled by a control circuit in communication circuit 110 or may be controlled by other processing circuits.

Communication circuit 110 also includes interfaces to send and receive data (e.g., audio and/or video signals) to other processing circuits (not shown). Communication circuit 100 further amplifies and processes the data in order to either provide the data to antenna 120 for transmission or to provide the data to the other processing circuits. Communication circuit 110 may receive or send audio, video, and/or data signals, either in an analog or digital signal format. In one embodiment, communication circuit 110 has an ethernet interface for communicating data to other processing circuits and wireless network interface for communicating with antenna 220. Communication circuit 110 includes processing circuits for converting signals between ethernet format and a wireless format (e.g., 3G, LTE, or 5G cellular format).

Antenna 120 interfaces signals between communication circuit 110 and the over-the air wireless network (e.g., a 3G, LTE, or 5G cellular network). In some embodiments, antenna 120 may be configured for transmitting and receiving wireless signals that are present over a range of frequencies. For instance, antenna 120 may be configured for transmitting and receiving wireless signals over a range of frequencies from 3300 megahertz (MHz) to 4200 (MHZ), referred to as the N77/N78 band. In one embodiment, antenna 120 may be configured for optimally transmitting and receiving wireless signals that are present in the N77/N78 band used within the range of frequencies for the LTE cellular service while having reduced transmission and reception capability for wireless signals present at frequencies outside of that frequency band.

Antenna 120 may be physically separated from communication circuit 110 in communication device 100. The separation may be necessary to prevent interference between the operation of antenna 120 and communication circuit 110. The separation may additionally or alternatively be necessary to allow proper or best positioning for the operation of antenna 120 with respect to area or space within communication device 100. In these instances, antenna 120 may be referred to as an antenna assembly. Antenna 120 may include a connection interface for communicating the transmitted and received signals with communication circuit 110. In some embodiments, the connection interface may utilize a coaxial cable for the signal connection and associated ground reference connection between antenna 120 and the interface at communication circuit 110.

It is worth noting that more than one antenna 120 may be used in communication device 100. The use of more than one antenna provides additional performance capability and control options. For example, in one embodiment, a first antenna may be oriented in a first orientation or axis with a second antenna oriented in a second orientation or axis different from the first orientation or axis. In another embodiment, two antennas may be located physically at opposite ends of communication device 100 or a larger apparatus that includes communication device 100.

Communication device 100 in FIG. 1 is described primarily as operating according to a cellular wireless network, such as 3G, LTE, or 5G. It should be appreciated by one skilled in the art that other network standards and protocols that incorporate a wireless physical interface may be used. For instance, communication device 100 may easily be configured to operate according to standards and protocols for a Bluetooth network, a WiMax network, a Wi-Fi network or any number of wireless network standards or protocols that are, or will be, available. Further, more than one of these networks may be used either alternatively or simultaneously together.

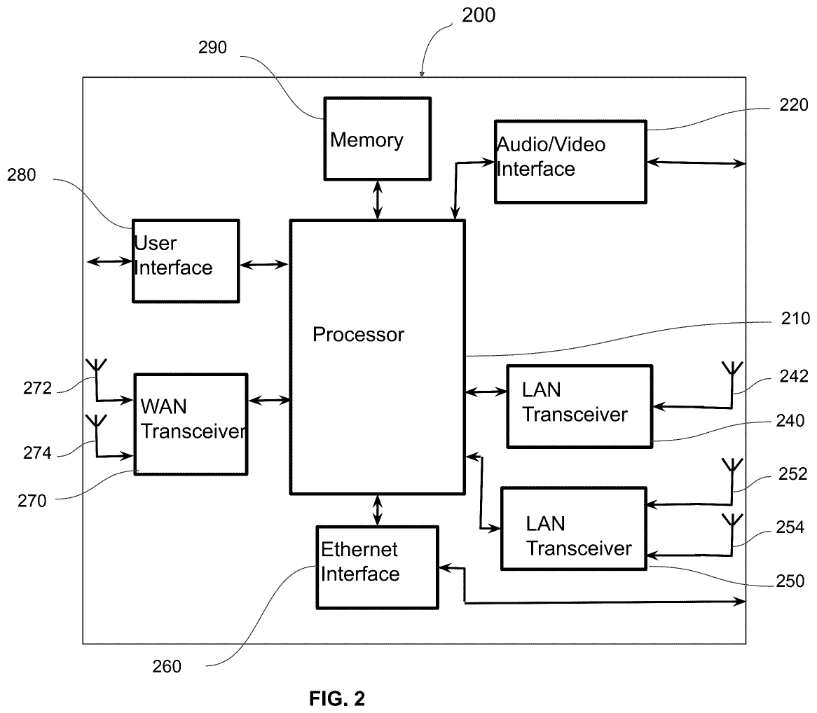

Turning to FIG. 2, a block diagram of an exemplary gateway device 200 according to aspects of the present disclosure is shown. Gateway device 200 may operate in a manner similar to communication device 100 described in FIG. 1. Gateway device 200 may be used at a customer premises or home to interface a WAN external to the premise to a LAN operating within the premises. In gateway device 200, a wide area network (WAN) is coupled to WAN transceiver 270 through antennas 272 and 274. WAN transceiver 270 is coupled to processor 210. Processor 210 is coupled to memory 290. Processor 210 is further coupled to audio/video interface 220, local area network (LAN) transceiver 240, LAN transceiver 250, and Ethernet interface 260. LAN transceiver 240 is coupled to antenna 242. LAN transceiver 250 is coupled to antenna 252 and antenna 254. A user interface 280 is further coupled to processor 210. It is to be appreciated that several components and interconnections necessary for complete operation of gateway device 200 are not shown in the interest of conciseness, as the components not shown are well known to those skilled in the art. Gateway device 200 is capable of operating as an interface to a WAN such as a cellular, satellite, microwave, or terrestrial communication network, and is further capable of providing an interface to one or more devices used in a home and connected through either a wired and wireless home network or LAN.

WAN transceiver 270 includes circuitry to perform network radio frequency (RF) signal modulation and transmission functions on a signal provided to the WAN through antennas 272 and 274 from gateway 200 as well as RF signal tuning and demodulation functions on a signal received from the WAN through antennas 272 and 274 at gateway 200. The RF modulation and demodulation functions are the same as those commonly used in communication systems, such as wireless, cellular, satellite and terrestrial systems. It is important to note that in some embodiments, the WAN transceiver 270 may be referred to as a tuner even though the tuner may also include modulation and transmission circuitry and functionality. Processor 210 receives the demodulated network communication signals from WAN transceiver 270 and provides any data or content, formatted for network delivery, to WAN transceiver 270 for modulation and transmission on the external network. WAN transceiver 270 may also include circuitry for signal conditioning, filtering, and/or signal conversion (e.g., optical to electrical signal conversion). Antennas 272 and 274 may be any type of antenna suitable for transmitting and/or receiving signals in the frequency range or ranges used by the WAN. In some embodiments, one or both of antennas 272 and 274 may be included within the structure of gateway device 200. In some embodiments, one or both of antennas 272 and 274 may be high gain dual-polarization antennas. In some embodiments, one or both of antennas 272 and 274 may utilize additional elements, such as reflectors, to improve antenna performance. In some embodiments, antenna 272 may be used for transmission of signals over the WAN and antenna 274 may be used for receiving signals over the WAN. In some embodiments, antennas 272 and 274 may be configured to operate using an antenna diversity mechanism. In some embodiments, antennas 272 and 274 may be configured to operate using a cooperative multiple-input-multiple-output (MIMO) antenna mechanism.

System memory 290 supports the content and data processing as well as internet protocol (IP) functions in processor 210 and also serves as storage for applications, programs, control code and media content and data information. System memory 290 may include one or more of the following storage elements including, but not limited to, RAM, ROM, Electrically-Erasable Programmable ROM (EEPROM), and flash memory. System memory 290 may also encompass one or more integrated memory elements including, but not limited to, magnetic media hard disk drives and optical media disk drives. Digital content and/or data stored in memory 290 may be retrieved by processor 210, processed, and provided to one or more of audio/video interface 220, phone interface 230, transceivers 240 and 250, Ethernet interface 260, WAN transceiver 270, and user interface 280.

Audio/video interface 220 allows connection to an audio/video reproduction device, such as a television display device described above or other media device, such as a set top box and the like. Audio/video interface 220 may include additional signal processing circuitry including, but not limited to, digital to analog converters, signal filters, digital and/or analog signal format converters, modulators, demodulators, and the like. Audio/video interface 220 also includes one or more physical connectors to connect to the audio/video reproduction device using one or more of several different types of audio/video connecting cables. The one or more physical connectors may include, but are not limited to, RCA or phone type connectors, HDMI connectors, digital visual interface (DVI) connectors, Sony/Philips digital interface (S/PDIF) connectors, Toshiba Link (Toslink) connectors, and F-type coaxial connectors.

Ethernet interface 260 allows connection to external devices (e.g., computer 250 described in FIG. 1) that are compliant with the IEEE 802.3 or similar communication protocol. Ethernet interface 260 includes a type RJ-45 physical interface connector or other standard interface connector to allow connection to an external local computer or other Ethernet connected device.

Processor 210 may be a programmable microprocessor that is reconfigurable with downloadable instructions or software code stored in memory 290. Processor 210 may alternatively be a specifically programmed controller and data processor with internal control code for controlling, managing, and processing all functions and data in gateway 200. Processor 210 is also operative to receive and process user input signals provided via user interface 280. User interface 280 may include a user input or entry mechanism, such as a set of buttons, a keyboard, or a microphone. User interface 280 may also include circuitry for converting user input signals into a data communication format to provide to processor 210. User interface 280 may further include some form of user notification mechanism to show device functionality or status, such as indicator lights, a speaker, or a display. User interface 280 may also include circuitry for converting data received from processor 210 to signals that may be used with the user notification mechanism.

LAN transceiver 240, along with antenna 242, and LAN transceiver 250, along with antennas 252 and 254, provide a wireless communication interface to other devices in a home network or LAN. LAN transceiver 240 and LAN transceiver 250 may include various electronic circuits for receiving and transmitting signals to other devices through antenna 242 and antennas 252 and 254, respectively. The various electronic circuits may include, but are not limited to, antenna switches, signal amplifiers, signal meters, frequency converters, modulators, demodulators, and transport processors. Further details regarding the configuration and operation of a transceiver similar to LAN transceiver 240 and LAN transceiver 250 will be described below.

It is important to note that LAN transceiver 240 and LAN transceiver 250 may operate using two different communication protocols. In some embodiments, LAN transceiver 240 communicates signals with other wireless devices through antenna 242 using an IEEE 802.11 protocol. LAN transceiver 250 additionally communicates signals with other wireless devices through antennas 252 and 254 using the Zigbee protocol. It is important to note that in other embodiments LAN transceiver 240 and LAN transceiver 250 may be configured to operate using other wireless communication protocols, such as Thread, Bluetooth, Z-Wave, and Wi-Fi. Antennas 242, 252, and 254 may be any type of antenna suitable for transmitting and/or receiving signals in the frequency range or ranges used by the LAN. In some embodiments, one or more of antennas 242, 252, and 254 may be included within the structure of gateway device 200. In some embodiments, one or more of antennas 242, 252, and 254 may be high gain dual-polarization antennas. In some embodiments, one or more of antennas 242, 252, and 254 may utilize additional elements, such as reflectors, to improve antenna performance. In some embodiments, antennas 252 and 254 may also be configured for one or more of a transmit/receive, antenna diversity, and MIMO operation.

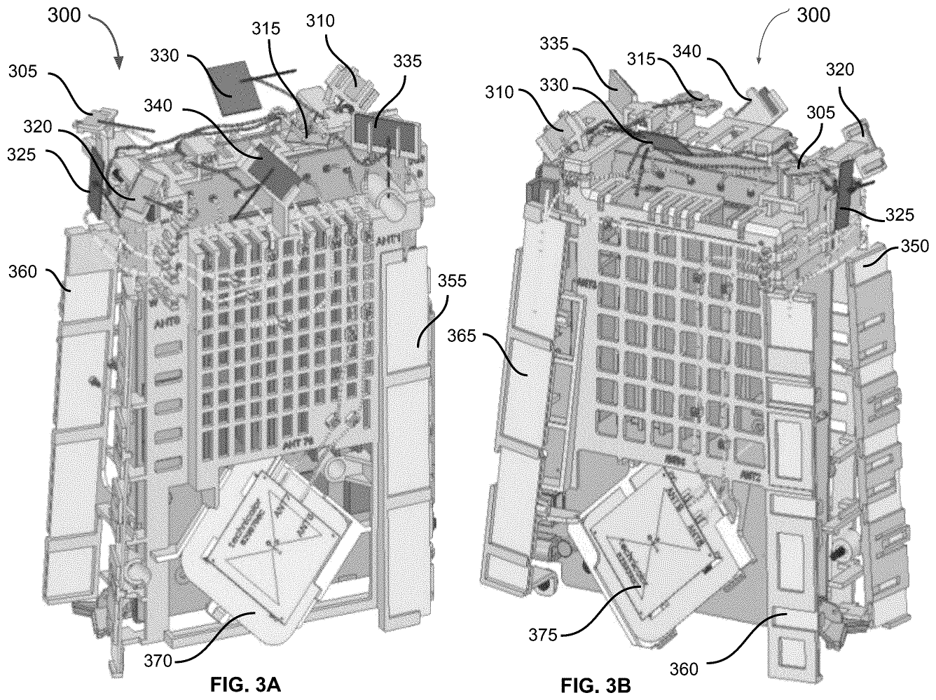

Turning now to FIG. 3A and 3B, a first and second perspective view of an exemplary electronic assembly 300 including a plurality of antennas and integrated antenna assemblies according to aspects of the present disclosure is shown. Electronic assembly 300 may be included as part of an apparatus used for wireless communications, such as gateway device 200 described in FIG. 2 or communication device 100 described in FIG. 1. Electronic assembly 300 is configured to be completely contained within the enclosure of the apparatus. However, in some embodiments, some portion of electronic assembly 300, including some or all of one or more of the antenna assemblies, may be located external to the enclosure. For purposes of reference, FIG. 3a shows a perspective view from the front side of electronic assembly 300 and FIG. 3b shows a perspective view from the opposite or back side of electronic assembly 300. It is important to note that not all antennas or antenna assemblies may be shown in each of the perspective views of FIGS. 3A and 3B. However, when an antenna or antenna assembly is shown in both perspective views of FIGS. 3A and 3B, the antenna or antenna assembly uses the same reference number.

Electronic assembly 300 includes antenna assemblies 305, 310, 315, and 320. Antenna assemblies 305, 310, 315, and 320 are configured to transmit and receive signals in the 5 GHz frequency band used for the Institute of Electrical and Electronics Engineers (IEEE) 802.11 wireless communication protocol, often referred to as Wi-Fi. Antenna assemblies 305, 310, 315, and 320 may operate independently as part of an antenna diversity system or may operate cooperatively as part of a multiple input multiple output (MIMO) antenna system. Antenna assemblies 305, 310, 315, and 320 may be physically positioned at different locations and may be oriented in different positions in order to improve either diversity of MIMO performance.

Electronic assembly 300 also includes antenna assemblies 325, 330, 335, and 340. Antenna assemblies 325, 330, 335, and 340 are configured to transmit and receive signals in the 2.4 GHz frequency band used for the IEEE 802.11 wireless communication protocol or Wi-Fi. Antenna assemblies 325, 330, 335, and 340 may operate as part of an antenna diversity system or MIMO antenna system as described. Antenna assemblies 325, 330, 335, and 340 may be physically positioned at different locations and may be oriented in different positions in a manner similar to that described above.

Electronic assembly 300 further includes antenna assemblies 350, 355, 360, and 365. Antenna assemblies 350, 355, 360, and 365 are configured to transmit and receive signals over the frequency range of 600 MHz to 2700 MHz, referred to as the worldwide cellular 4G-LTE band, as well as the frequency range of 3300 MHz to 4200 MHZ (N77/N78band) used for the cellular 5G communication protocol. Antenna assemblies 350, 355, 360, and 365 are configured as low gain wideband antennas. Antenna assemblies 350, 355, 360, and 365 may operate as part of an antenna diversity system or MIMO antenna system as described above. Antenna assemblies 350, 355, 360, and 365 may be physically positioned at different locations and may be oriented in different positions in a manner similar to that described above.

Electronic assembly 300 further includes antenna assemblies 370, and 375. Antenna assemblies 370, and 375 are configured to transmit and receive signals in the frequency range of 3300 MHz to 4200 MHz (N77/N78 band) used for the cellular 5G communication protocol. Antenna assemblies 370 and 375 are configured to operate as high gain dual-polarization directional antennas. Antenna assemblies 370, and 375 may operate as part of an antenna diversity system or MIMO antenna system as described. Antenna assemblies 370 and 375 may be physically positioned at different locations and may be oriented in different positions in a manner similar to that described above.

Electronic assembly 300 may include additional antennas not shown in FIGS. 3A and 3B. In some embodiments, these additional antennas may be printed or formed as a pattern on a printed circuit board in electronic assembly 300. In some embodiments, these additional antennas may be formed out of conductive material, such as copper, and attached to a printed circuit board. For example, electronic assembly 300 may include an antenna printed on a circuit board that operates in the 2.4 GHz frequency band used for communication protocols associated with an internet of things (IoT) network. Electronic assembly 300 may also include two antennas mounted to a printed circuit board and formed out of conductive material (e.g., copper) and operate in the 1500 MHz frequency band, referred to as B32 band for using cellular LTE/4G communication protocols. It is worth noting that in some embodiments, the number of antennas and/or antenna assemblies included as part of an electronic assembly may be more or fewer than described here for electronic assembly 300.

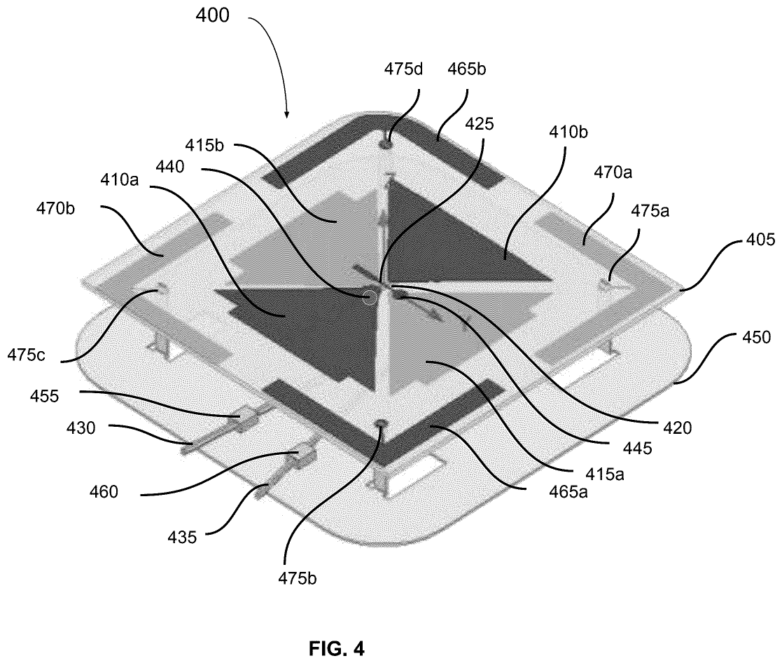

Turning now to FIG. 4, a diagram of an exemplary antenna assembly 400 according to aspects of the present disclosure is shown. Antenna assembly 400 may be included as part of an apparatus used for wireless communications, such as communication device 100 described in FIG. 1 or gateway device 200 described in FIG. 2. More specifically, antenna assembly 400 may be used for one or more of antenna assemblies 370, 375 described in FIG. 3. Antenna assembly 400 may be referred to as a dual-polarized high gain antenna for use over a range of frequencies, or a frequency band, associated with wireless network communications as described above.

Antenna assembly 400 includes a printed circuit board 405 that provides a base material for supporting a group of conductive traces in a pattern layout. Printed circuit board 405 is made from a non-conductive rigid laminate material that is typically designed for use with radio frequency (RF) circuitry. The laminate material typically may have a thickness between 0.5 millimeters (mm) and 1.625 mm. In the present embodiment, the laminate material has a thickness of 0.6 mm. Printed circuit board 405 also has a layer of conductive material, such as copper, laminated to both surfaces of the laminate from which a pattern of conductive elements may be etched. This arrangement for printed circuit board 405 may be referred to as a double layer or double sided printed circuit board. The pattern conductive elements are the antenna elements which form the antenna structures along with the additional elements used in antenna assembly 400.

Although antenna assembly 400 uses a double layer printed circuit board for printed circuit 405, other embodiments may utilize a single layer printed circuit board, where a conductive layer is only laminated on one surface of the laminate material. In still other embodiments, a multi-layer printed circuit board may be used. A multi-layer printed circuit board is constructed using two or more laminates that have conductive layers attached to the outer layers as well as in between each of the two or more laminates, all bonded together. Each of the conductive layers may have the same or different patterns of conductive elements etched from the conductive material.

Antenna assembly 400 also includes a first set of conductive elements 410a and 410b on a first, or top, surface of printed circuit board 405. Conductive elements 410a and 410b are shown as triangular in shape with one of the vertices of each of the elements pointing to each other. A conductive element 420 is included on a second, or bottom, surface at or near the center of printed circuit board 405. Conductive element 420 is coupled between the vertices of conductive elements 410a and 410b that are pointing to each other. Conductive element 420 is connected to conductive elements 410a and 410b through the laminate material from top to bottom using an electrical connection mechanism, such as a solder connection or a plated via. Conductive elements 410a and 410b, along with conductive element 420, form the active elements of a first bow-tie antenna structure oriented in a first polarization orientation.

Antenna assembly 400 also includes a second set of conductive elements 415a and 415b on the second, or bottom, surface of printed circuit board 405. Conductive elements 415a and 415b are shown having a similar shape to conductive elements 410a and 410b but are positioned orthogonal to conductive elements 410a and 410b. A conductive element 425 is included on the first, or top, surface at or near the center of printed circuit board 405. Conductive element 425 is coupled between the vertices of conductive elements 415a and 415b in a manner similar to that described above. Conductive elements 415a and 415b, along with conductive element 425, form the active elements of a second bow-tie antenna structure oriented in a second polarization orientation orthogonal to the first bow-tie antenna structure.

The dimensions of conductive elements 410a and 410b and conductive elements 415a and 415b may be empirically and/or experimentally determined based on the required or desired operational characteristics of the antenna structure (e.g., a bow-tie antenna structure). For example, conductive elements 410a and 410b and conductive elements 415a and 415b span an area approximately 35 mm by 35 mm in order to operate optimally over the frequency range of 3300 MHz to 4200 MHz. Additional details may be added to one or more of conductive elements 410a and 410b and conductive elements 415a and 415b in order to fine tune the operational frequency range as well as other operating characteristics for the antenna structures. As shown, conductive element 410a is triangular while conductive elements 410a, 415a, and 415b are triangular with an extension along a portion of one side of the triangular shape, making the shape more arrow-like. The extension along the point of the one side extends the operational frequency bandwidth or frequency range of the antenna structures.

Antenna assembly 400 further includes a coaxial cable 430 and coaxial cable 435 used to interface RF signals between a communication circuit in an apparatus (e.g., communication circuit 110 in FIG. 1) and the first bow-tie antenna structure and second bow-tie antenna structure, respectively. Antenna assembly 400 additionally includes a conductive plate 450 that is positioned parallel to and below the bottom surface of printed circuit board 405. The conductive plate 450 is positioned, or spaced, a predefined distance from the bottom surface of printed circuit board 403. The predefined distance may be empirically and/or experimentally determined based on the required or desired operational characteristics of plate 450 in conjunction with the first and second bow-tie antenna structures. In one embodiment, the distance is 8.4 mm. The distance may be different in other embodiments and is part of the characteristics used in determining the operational performance of antenna assembly 400. The distance is maintained using a conductive structure to electrically and/or mechanically couple conductive plate 450 to printed circuit board 405. As shown, the conductive structure is a set of four conductive tabs cut and/or formed out of conductive plate 450 and oriented perpendicular to the surface of conductive plate 450. The ends of the conductive tabs are affixed (e.g., soldered) to printed circuit board 405 at connection points 475, 475b, 475c, and 475d. In other embodiments, other structures may be used to position and affix conductive plate 450 to printed circuit board at the defined spacing or distance from printed circuit board 405 including, but limited to, conductive screws, conductive screw-in standoffs, electrical wire, and the like.

The dimensions of conductive plate 450 may be determined based on the operational characteristics, such as the frequency range, for the antenna assembly. The thickness may range from 0.1 mm to 1 mm. In an embodiment, the thickness is 0.3 mm. The conductive plate 450 may also include a non-conductive backing material, such as plastic, to provide additional rigidity. The length and width dimensions may be similar to the dimensions for printed circuit board 405, although it may be advantageous for conductive plate 450 to be larger in area than printed circuit board 405. As described above, the dimensions for conductive plate determine, in part, the antenna for antenna assembly 400 while the dimensions may be practically limited by the space available within the communication device (e.g., electronic assembly 300 in FIG. 3). In an embodiment, conductive plate 450 spans an area 59 mm by 59 mm while printed circuit board 405 spans an area 49 mm by 49 mm.

The conductive plate 450 described above may be referred to as a reflecting element or reflector. The operational characteristics of the first and second bow-tie antenna structures are modified, adjusted, or tuned, based on the shape and dimensions of conductive plate 450 as well as the distance between conductive plate 450 and the first and second bow-tie antenna structures.

It is worth noting that the area of printed circuit board 405 is larger than the area needed or required for implementation of the first and second bow-tie antennas structures described above. The additional area allows for a connection and securing point for the conductive tabs or similar support mechanisms from conductive plate 450 for supporting printed circuit board 405. The additional area also allows additional conductive traces to be included, surrounding the first and second bow-tie antenna structures. It is further worth noting that although four conductive tabs located near the four corners of conductive plate 450 are used to support printed circuit board 405, in other embodiments, more or fewer conductive tabs as well as different placements of tabs may be used.

Coaxial cables 430 and 435 are positioned to pass through the space between conductive plate 450 and the bottom surface of printed circuit board 405 (not shown). The center conductor of coaxial cable 430 attaches to the first bow-tie antenna structure at a signal interface point 440 near the connection of the vertex of conductive element 410a and conductive element 420. The center conductor of coaxial cable 435 attaches to the second bow-tie antenna structure at a signal interface point 445 near the connection of the vertex of conductive element 415a and conductive element 425. The outer ground shield of coaxial cable 430 is attached to conductive plate 450 at ground interface point 455. Similarly, the outer ground shield of coaxial cable 435 is attached to conductive plate 450 at ground interface point 460. The connections may be made using a soldering mechanism or a plug and socket interface mechanism suitable for RF.

Antenna assembly 400 also includes conductive elements 465a and 465b on the top surface of printed circuit board 405. Conductive elements 465a and 465b are each shown as two linear sections forming a right angle with their vertices at diagonally opposite corners and extending along the edges of printed circuit board 405. A further connection is made between the vertices of each of conductive elements 465a and 465b to the connection points 475b and 475d. In this manner, conductive elements 465a and 465b are electrically coupled to conductive plate 450 through the conductive structure positioning the conductive plate 450 and printed circuit board 405.

Antenna assembly 400 further includes conductive elements 470a and 470b on the bottom surface of printed circuit board 405. Conductive elements 470a and 470b are each shown as two linear sections forming a right angle with their vertices at the two other diagonally opposite corners and extending along the edges of printed circuit board 405 with respect to conductive elements 465a and 465b. A further connection is made between the vertices of each of conductive elements 470a and 470b to the connection points 475a and 475c. In this manner, conductive elements 465a and 465b are electrically coupled to conductive plate 450 as described above.

Conductive elements 465a, 465b, 470a, and 470b, may be referred to as reflective elements in a manner similar to that described above for conductive plate 450. As with conductive plate 450, the shape and dimensions of conductive elements 465a, 465b, 470a, and 470b as well as the distance between elements and the first and second bow-tie antenna structures may be adjusted to tune the operational performance of antenna assembly 400. The conductive plate 450 along with the addition of conductive elements 465a, 465b, 470a, and 470b electrically connected through a conductive support mechanism to conductive plate 450 form an inexpensive and easy to manufacture three dimensional open reflector structure, similar to an open box reflector or reflective cavity, that effectively surrounds the first and second bow-tie antenna structures from the sides of and below printed circuit board 405. As will be seen, the addition of conductive elements 465a, 465b, 470a, and 470b, as described here, improve the operational performance, and in particular the antenna gain and directivity, of antenna assembly 400 over the same design without those conductive elements.

It is worth noting that the corner of printed circuit board 405 near conductive element 465b, along with conductive element 465b has a radial or curved corner shape in order to comply with the size and space limitations for antenna assembly 400 in the communication device (e.g., electronic assembly 300 in FIG. 3). The presence of such a modification has minimal effect on the operational performance of antenna assembly 400. Further, the effect on the operational performance may be further adjusted or tuned out to account for the modification.

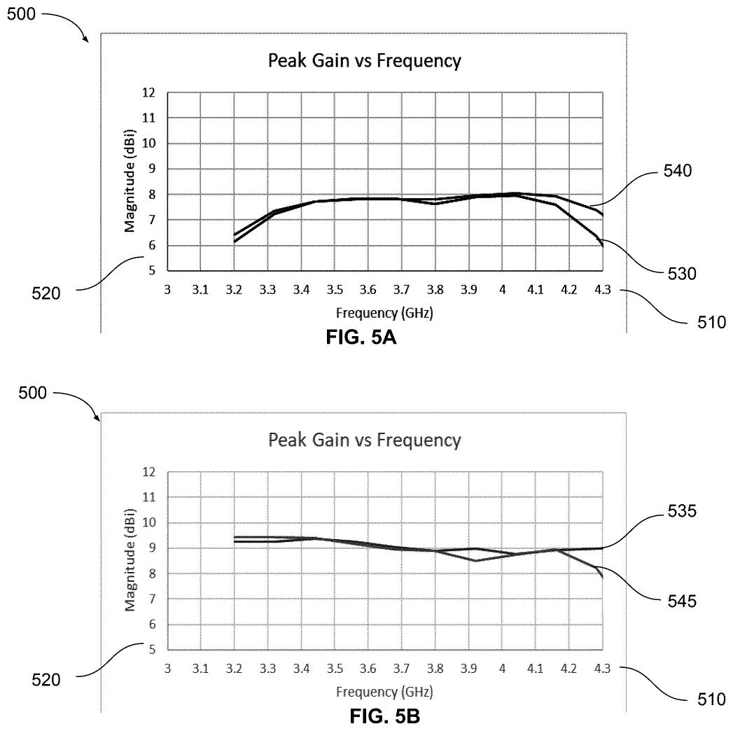

Turning now to FIGS. 5A and 5B, a pair of graphs 500 illustrating a set of electrical characteristics associated with operation performance of two similar antenna structures in accordance with aspects of the present disclosure are shown. Each of the graphs 500 represents the design simulation results for the magnitude of peak antenna gain values, displayed over a frequency range. More specifically, graph 500 in FIG. 5A displays the peak antenna gain values versus frequency for each of the antenna structures (i.e., bow-tie antenna structures) included in an antenna assembly similar to antenna assembly 400 described in FIG. 4 without the inclusion of the open box reflector or reflective cavity structure (e.g., conductive elements 465a, 465b, 470a, and 470b along with conductive plate 450). Graph 500 in FIG. 5B displays the peak antenna gain values versus frequency for each of the antenna structures included in the antenna assembly similar to antenna assembly 400 with the inclusion of the open box reflector or reflective cavity structure described in FIG. 4. The peak antenna gain values for each of the antenna structures are measured at the coaxial cables connected to the antenna assembly (i.e., coaxial cables 430 and 435).

Graphs 500 include an x-axis 510 displaying frequency measured in gigahertz (GHz). Graphs 500 also include a y-axis 520 displaying the magnitude of peak gain for each antenna structure measured in decibels relative to an isotropic antenna (dBi). In FIG. 5A, line 530 displays the value of peak gain versus frequency for the first bow-tie antenna structure included in the antenna assembly without the open box reflector or reflective cavity structure. Further, line 540 displays the value of peak gain versus frequency for the second bow-tie antenna structure included in the antenna assembly without the open box reflector or reflective cavity structure. In FIG. 5B, line 535 displays the value of peak gain versus frequency for the first bow-tie antenna structure included in the antenna assembly similar to that described in FIG. 4 (i.e., without the open box reflector or reflective cavity structure). Further, line 545 displays the value of peak gain versus frequency for the second bow-tie antenna structure included in the antenna assembly similar to that described in FIG. 4. The peak antenna gain performance is shown in graph 500 of FIG. 5B, especially over the 5G cellular N77/N78 frequency band (i.e., 3.3 GHz to 4.2 GHz), is greater than 1 to 1.5 dBi more, or greater, than the peak antenna gain performance shown in graph 500 of FIG. 5A.

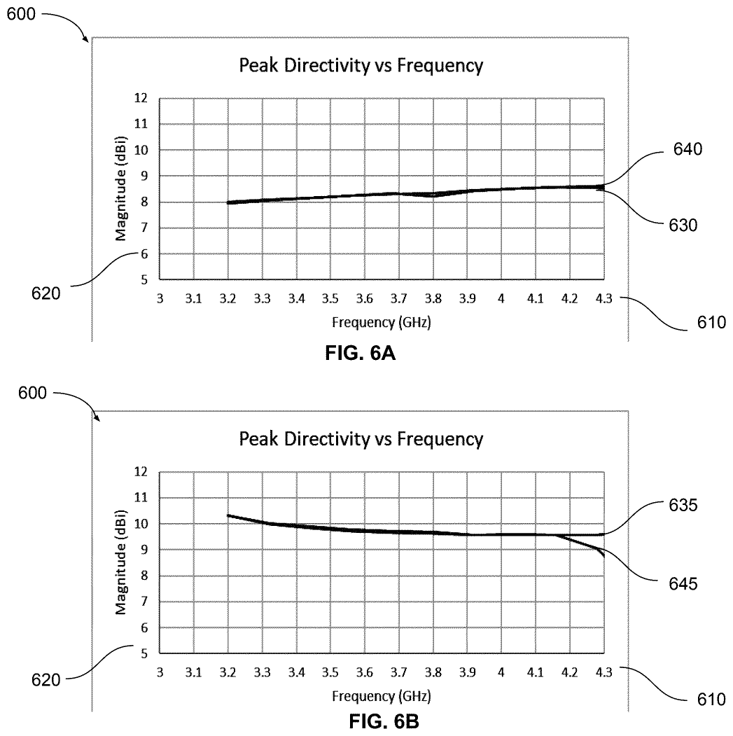

Turning now to FIGS. 6A and 6B, a pair of graphs 600 illustrating another set of electrical characteristics associated with operation performance of two similar antenna structures in accordance with aspects of the present disclosure are shown. Each of the graphs 600 represents the design simulation results for the magnitude of peak directivity values, displayed over a frequency range. More specifically, graphs 600 in FIGS. 6A and 6B display the peak directivity values versus frequency for the same antenna assemblies as described above for FIG. 5A and FIG. 5B, respectively. The peak directivity values for each of the antenna structures are measured in the same manner as described above.

Graphs 600 include an x-axis 610 displaying frequency in gigahertz (GHz). Graphs 600 also include a y-axis 620 displaying the magnitude of peak directivity for each antenna structure in dBi. In FIG. 6A, line 630 displays the value of peak directivity versus frequency for the first bow-tie antenna structure included in the antenna assembly similar to that described in FIG. 4 without reflective elements. Further, line 640 displays the value of peak directivity versus frequency for the second bow-tie antenna structure included in the antenna assembly similar to that described in FIG. 4 without reflective elements. In FIG. 6B, line 635 dsplays the value of peak directivity versus frequency for the first bow-tie antenna structure included in the antenna assembly similar to that described in FIG. 4. Further, line 645 displays the value of peak directivity versus frequency for the second bow-tie antenna structure included in the antenna assembly similar to that described in FIG. 4. The peak directivity performance shown in graph 600 in FIG. 6B, especially over cellular 5G N77/N78 frequency band, is 1 to 1.5 dBi more, or greater, than the peak directivity performance shown in graph 600 of FIG. 6A.

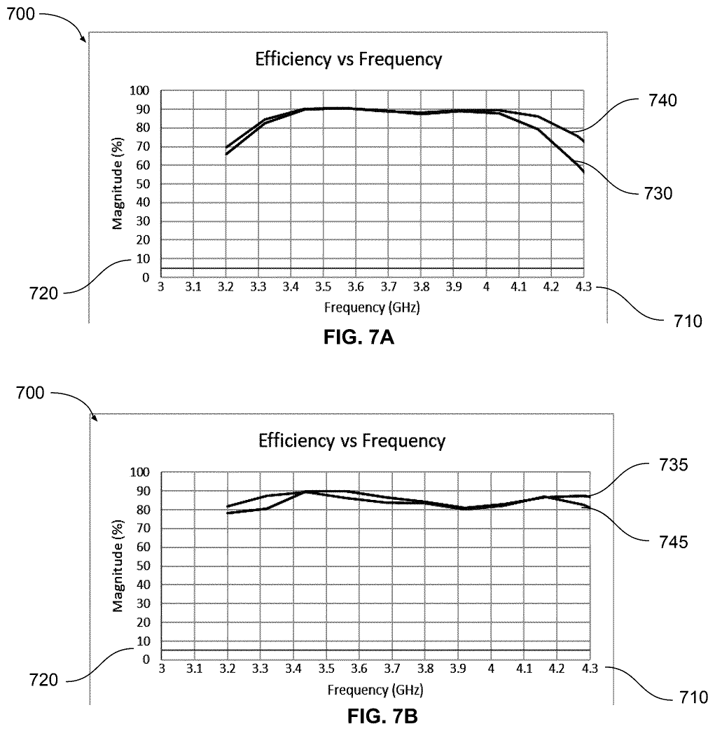

Turning now to FIGS. 7A and 7B, a pair of graphs 700 illustrating a further set of electrical characteristics associated with operation performance of two similar antenna structures in accordance with aspects of the present disclosure are shown. Each of the graphs 700 represents the design simulation results for the antenna efficiency values, displayed over a frequency range. More specifically, graphs 700 in FIG. 7A and FIG. 7B displays the antenna efficiency values versus frequency for the same antenna assemblies as described above for FIG. 5A and FIG. 5B, respectively. The antenna efficiency values for each of the antenna structures are measured in the same manner as described above.

Graphs 700 include an x-axis 710 displaying frequency in gigahertz (GHz). Graphs 700 also include a y-axis 720 displaying the magnitude of antenna efficiency for each antenna structure in percent (%). In FIG. 7A, line 730 displays the value of antenna efficiency versus frequency for the first bow-tie antenna structure included in the antenna assembly similar to that described in FIG. 4 without the open box reflector or reflective cavity structure. Further, line 740 displays the value of antenna efficiency versus frequency for the second bowtie antenna structure included in the antenna assembly similar to that described in FIG. 4 without the open box reflector or reflective cavity structure. In FIG. 7B, line 735 displays the value of antenna efficiency versus frequency for the first bow-tie antenna structure included in the antenna assembly similar to that described in FIG. 4. Further, line 745 displays the value of antenna efficiency versus frequency for the second bow-tie antenna structure included in the antenna assembly similar to that described in FIG. 4. The antenna efficiency performance shown in graph 700 in FIG. 7A, and the antenna efficiency performance shown in graph 700 in FIG. 7B have similar antenna efficiency, and both exceed 80% antenna efficiency, especially over the cellular 5G N77/N78 frequency band.

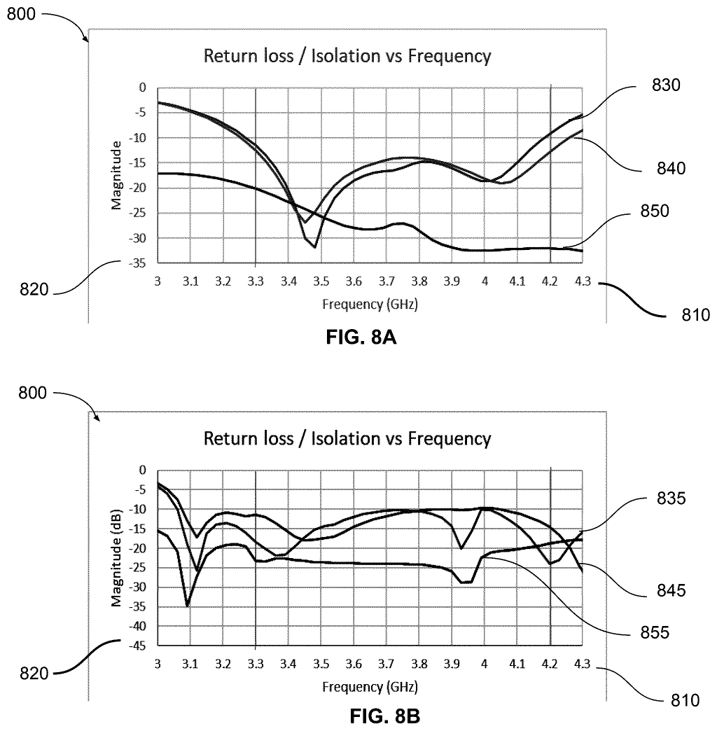

Turning now to FIGS. 8A and 8B, a pair of graphs 800 illustrating yet another set of electrical characteristics associated with operation performance of two similar antenna structures in accordance with aspects of the present disclosure are shown. Each of the graphs 800 represents the design simulation results for the return loss values, along with antenna signal isolation values, displayed over a frequency range. More specifically, graphs 800 in FIGS. 8A and 8B display the return loss values and antenna signal isolation values versus frequency for the same antenna assemblies as described above for FIG. 5A and FIG. 5B, respectively. The antenna return loss values and antenna isolation values for each of the antenna structures are measured in the same manner as described above.

Graphs 800 include an x-axis 810 displaying frequency in gigahertz (GHz). Graphs 800 also include a y-axis 820 displaying the magnitude of return loss for each antenna structure as well as the magnitude of antenna signal isolation between each antenna structure in dB. In FIG. 8A, line 830 displays the value of return loss versus frequency for the first bow-tie antenna structure included in the antenna assembly similar to that described in FIG. 4 without the open box reflector or reflective cavity structure. Further, line 840 displays the value of return loss versus frequency for the second bow-tie antenna structure included in the antenna assembly similar to that described in FIG. 4 without the open box reflector or reflective cavity structure. Additionally, line 850 displays the value for antenna signal isolation between the first bow-tie antenna structure and the second bow-tie antenna structure included in the antenna assembly similar to that described in FIG. 4 without reflective elements. In FIG. 8B, line 835 displays the value of return loss versus frequency for the first bow-tie antenna structure included in the antenna assembly similar to that described in FIG. 4. Further, line 845 displays the value of return loss versus frequency for the second bow-tie antenna structure included in the antenna assembly similar to that described in FIG. 4. Additionally, line 855 displays the value for antenna signal isolation between the first bow-tie antenna structure and the second bow-tie antenna structure included in the antenna assembly similar to that described in FIG. 4. The return loss and antenna isolation performance shown in graph 800 in FIG. 8A, and the return loss and antenna isolation performance shown in graph 800 in FIG. 8B both achieve a return loss of less than −10 dB and an antenna signal isolation of less than −20 dB, especially over the cellular 5G N77/N78 frequency band.

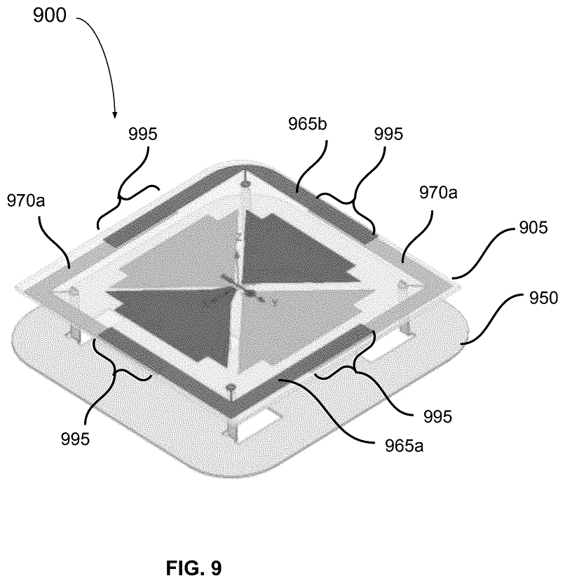

Turning now to FIG. 9, a diagram of another exemplary antenna assembly 900 according to aspects of the present disclosure is shown. Antenna assembly 900 may be included as part of an apparatus used for wireless communications, such as communication device 100 described in FIG. 1 or gateway 200 described in FIG. 2. More specifically, antenna assembly 900 may be used for one or more of antenna assemblies 370, 375 described in FIG. 3. Antenna assembly 900 may be referred to as a dual-polarized high gain antenna for use over a range of frequencies, or a frequency band, associated with wireless network communications as described above. Except as described below, the structure, orientation, and operation of any elements not described for antenna assembly 900 are similar to the structure, orientation, and operation of those same elements described for antenna assembly 400 in FIG. 4 above and will not be described in further detail here.

Antenna assembly 900 includes conductive elements 965a and 965b on the top surface of printed circuit board 905 and conductive elements 970a and 970b on the bottom surface of printed circuit board 905. The shape of conductive elements 965a and 965b and conductive elements 970a and 970b are similar to those same elements in antenna assembly 400 except that the length of each of the linear sections overlap each other in regions 995 in the x and y directions. The overlapping regions 995 are not electrically connected to each other in part because conductive elements 965a and 965b and conductive elements 970a and 970a are located on opposite sides of the printed circuit board. Conductive elements 965a and 965b and conductive elements 970a and 970b operate as reflective elements in conjunction with the reflector formed by conductive plate 950 in a manner similar to that described above. The dimensions, including the length and position of the overlap regions 995, may be adjusted to change or tune the operational performance of antenna assembly 900.

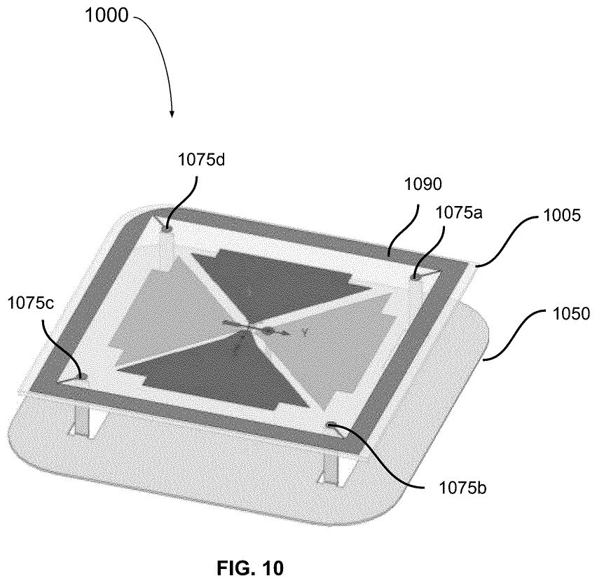

Turning now to FIG. 10, a diagram of another exemplary antenna assembly 1000 according to aspects of the present disclosure is shown. Antenna assembly 1000 may be included as part of an apparatus used for wireless communications, such as communication device 100 described in FIG. 1 or gateway 200 described in FIG. 2. More specifically, antenna assembly 1000 may be used for one or more of antenna assemblies 370, 375 described in FIG. 3. Antenna assembly 1000 may be referred to as a dual-polarized high gain antenna for use over a range of frequencies, or a frequency band, associated with wireless network communications as described above. Except as described below, the structure, orientation, and operation of any elements not described for antenna assembly 1000 are similar to the structure, orientation, and operation of those same elements described for antenna assembly 400 in FIG. 4 above and will not be described in further detail here.

Antenna assembly 1000 includes a conductive element 1090 on the top surface of printed circuit board 1005. Conductive element 1090 is shown as a rectangular ring surrounding the first bow-tie antenna structure and the second bow-tie antenna structure following the shape of printed circuit board 1005. A further connection is made between the vertices at each corner of the rectangular ring formed by conductive element 1090 to the connection points 1075a, 1075b, 1075c, and 1075d. In this manner, conductive element 1090 is electrically coupled to conductive plate 1050 through the conductive structure positioning conductive plate 1050 and printed circuit board. Conductive element 1090 operates as a reflective element in a manner similar to the combination of conductive elements 465a and 465b and conductive elements 470a and 470b in conjunction with conductive plate 1050 as described above. Conductive element 1090 may be adjusted to change or tune the operational performance of antenna assembly 1000 in a manner similar to that described above.

It is worth noting that although antenna assembly 1000 describes conductive element 1090 on the top surface of printed circuit board 1005, in other embodiments conductive element 1090 may be on the bottom surface of printed circuit board 1005. Further, in some embodiments, a conductive element similar to conductive element 1090 may be on both the top surface and the bottom surface and may further be electrically connected together through printed circuit board 1005 using one or techniques similar to those described above.

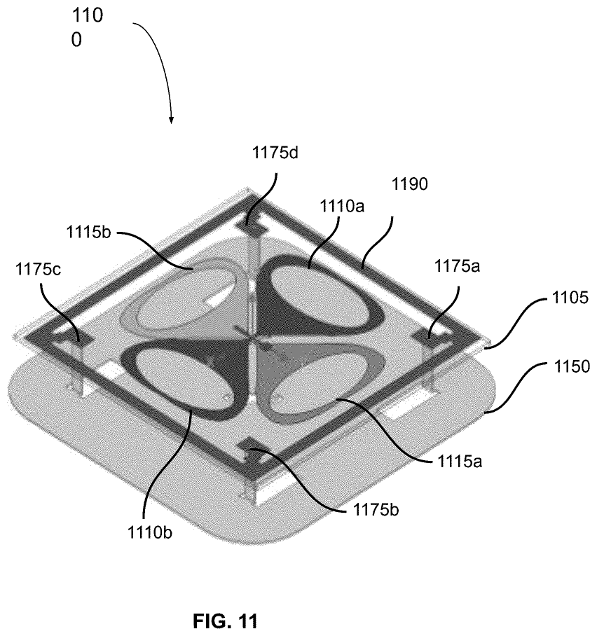

Turning now to FIG. 11, a diagram of another exemplary antenna assembly 1100 according to aspects of the present disclosure is shown. Antenna assembly 1100 may be included as part of an apparatus used for wireless communications, such as communication device 100 described in FIG. 1 or gateway 200 described in FIG. 2. More specifically, antenna assembly 1100 may be used for one or more of antenna assemblies 370, 375 described in FIG. 3. Antenna assembly 1100 may be referred to as a dual-polarized high gain antenna for use over a range of frequencies, or a frequency band, associated with wireless network communications as described above. Except as described below, the structure, orientation, and operation of any elements not described for antenna assembly 1100 are similar to the structure, orientation, and operation of those same elements described for antenna assembly 400 in FIG. 4 above and will not be described in further detail here.

Antenna assembly 1100 includes a first set of conductive elements 1110a and 1110b on the top surface of printed circuit board 1105. Conductive elements 1110a and 1110b are shown as a teardrop in shape having an oval opening in the middle with one of the points of each of the teardrops pointing to each other. Antenna assembly 1100 also includes a second set of conductive elements 1115a and 1115b on the bottom surface of printed circuit board 1105. Conductive elements 1115a and 1115b are shown with a shape similar to conductive elements 1110a and 1110b but are positioned orthogonal to conductive elements 1110a and 1110b. Conductive elements 1110a and 1110b and conductive element 1115a and 1115b are each connected together in a manner similar to that described in FIG. 4. Antenna assembly also includes a conductive element 1190 and connection points 1175a, 1175b, 1175c, and 1175d that are both structurally and operationally the same as conductive element 1090 and connection points 1075a, 1075b, 1075c, and 1075d described in FIG. 10.

Conductive elements 1110a and 1110b and conductive elements 1115a and 1115b may be referred to as a first loop dipole antenna structure and a second loop dipole antenna structure, respectively. The antenna operational characteristics of the first loop dipole antenna structure and second loop dipole antenna structure are different from the operational characteristics of the bow-tie antenna structures described in FIG. 4. However, the presence of the reflective element 1190 in conjunction with the reflector formed by conductive plate 1150 will produce a similar improvement in operational performance similar to that shown in FIGS. 5A and 5B as well as FIGS. 6A and 6B with respect to loop dipole antenna structures.

It is worth noting that while antenna assemblies utilizing bow-tie antenna structures and loop dipole antenna structures have been described utilizing aspects of the present disclosure, other antenna structures may also be utilized. These antenna structures include, but are not limited to, patch antennas, printed inverted F antennas, dipole antennas, Yagi antennas, planar horn antennas, and the like. Further, embodiments that utilize aspects of the present disclosure are not limited to dual-polarized antenna structures and may also be utilized with multi-band antenna structures as well as single polarized antenna structures.

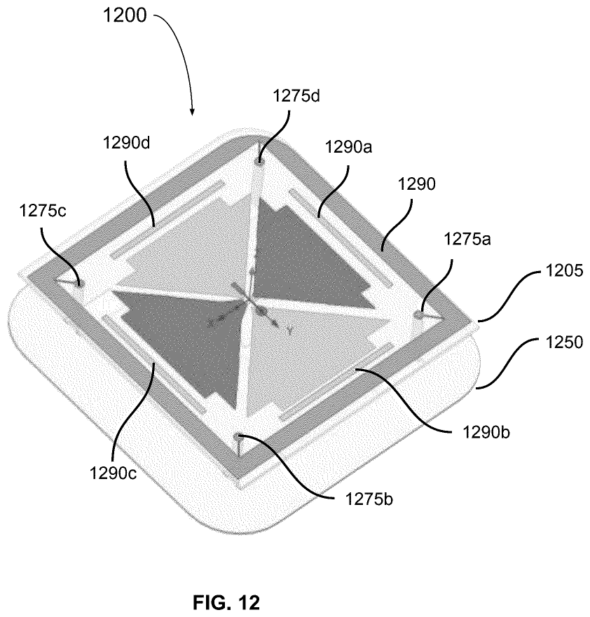

Turning now to FIG. 12, a diagram of another exemplary antenna assembly 1200 according to aspects of the present disclosure is shown. Antenna assembly 1200 may be included as part of an apparatus used for wireless communications, such as communication device 100 described in FIG. 1 or gateway 200 described in FIG. 2. More specifically, antenna assembly 1200 may be used for one or more of antenna assemblies 370, 375 described in FIG. 3. Antenna assembly 1200 may be referred to as a dual-polarized high gain antenna for use over a range of frequencies, or a frequency band, associated with wireless network communications as described above. Except as described below, the structure, orientation, and operation of any elements not described for antenna assembly 1200 are similar to the structure, orientation, and operation of those same elements described for antenna assembly 400 in FIG. 4 above and will not be described in further detail here.

Antenna assembly 1200 includes a conductive element 1290 on the top surface of printed circuit board 1205. Conductive element 1290 is shown as a rectangular ring surrounding the first bow-tie antenna structure and the second bow-tie antenna structure following the shape of printed circuit board 1205. A further connection is made between the vertices of the rectangular ring formed by conductive element 1290 to the connection points 1275a, 1275b, 1275c, and 1275d. Conductive element 1290 is connected to conductive plate 1250 and operates as a reflective element in a manner similar to conductive element 1090 described in FIG. 10.

Antenna assembly 1200 further includes a set of conductive elements 1290a, 1290b, 1290c, and 1290d on the bottom surface of printed circuit 1205. Each of conductive elements 1290a, 1290b, 1290c, and 1290d span a length for a portion of the length parallel to each side of printed circuit board 1205. Each of conductive elements 1290a, 1290b, 1290c, and 1290d is positioned on printed circuit board 1205 between conductive element 1290 and one of the elements of the first bow-tie antenna structure or second bow-tie antenna structure without being electrically connected. As shown, conductive elements 1290a, 1290b, 1290c, and 1290d act as parasitic elements that, in conjunction with the reflector and reflective elements described above, may be used to change or tune the operational performance of the antenna assembly.

It is worth noting that although antenna assembly 1200 describes conductive element 1290 on the top surface of the printed circuit board, in other embodiments conductive element 1290 may be on the bottom surface of the printed circuit board. Further, in some embodiments, a conductive element similar to conductive element 1290 may be on both the surface and the bottom surface and may further be electrically connected together through the printed circuit board using one or techniques similar to those described above. In some embodiments, one or more of conductive elements 1290a, 1290b, 1290c, and 1290d may be electrically connected to either conductive element 1290 or conductive plate 1250. In these embodiments, the conductive element(s) connected to either conductive element 1290 or conductive plate 1250 operate as a reflective element.

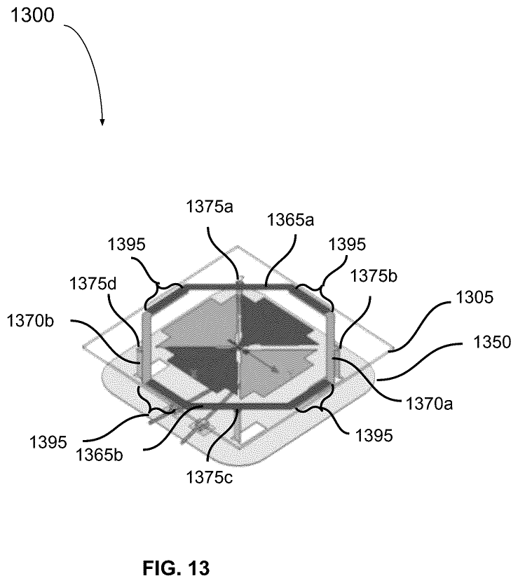

Turning now to FIG. 13, a diagram of another exemplary antenna assembly 1300 according to aspects of the present disclosure is shown. Antenna assembly 1300 may be included as part of an apparatus used for wireless communications, such as communication device 100 described in FIG. 1 or gateway 200 described in FIG. 2. More specifically, antenna assembly 1300 may be used for one or more of antenna assemblies 370, 375 described in FIG. 3. Antenna assembly 1300 may be referred to as a dual-polarized high gain antenna for use over a range of frequencies, or a frequency band, associated with wireless network communications as described above. Except as described below, the structure, orientation, and operation of any elements not described for antenna assembly 1300 are similar to the structure, orientation, and operation of those same elements described for antenna assembly 400 in FIG. 4 above and will not be described in further detail here.

Antenna assembly 1300 includes conductive elements 1365a and 1365b on the top surface of printed circuit board 1305 and conductive elements 1370a and 1370b on the bottom surface of printed circuit board 1305. The shape of conductive elements 1365a and 1365b and conductive elements 1370a and 1370b form three linear sections having angular vertices between them, with a longer center section connected at each end to one of the two shorter sections. The longer sections of each are angled with respect to the sides of the printed circuit board. The shorter sections of each are positioned in parallel to the sides of printed circuit 1305 as well as one side of either the first bow-tie antenna structure or the second bow-tie antenna structure having angular vertices between them. Further, the shorter sections of conductive element 1365a and 1365b each overlap the shorter sections of the adjacent conductive elements 1370a and 1370b at regions 1395 in a manner similar to that described for antenna assembly 900 in FIG. 9. The combination of conductive elements 1365a and 1365b and conductive elements 1370 and 1370b form a shape of an irregular octagon around the first bow-tie antenna structure or the second bow-tie antenna structure. Conductive elements 1365a and 1365b and conductive elements 1370a and 1370b are coupled at a midpoint of the longer sections to conductive plate 1350 through connection points 1375a, 1375b, 1375c, and 1375d in a manner similar to that described above. Conductive elements 1365a and 1365b and conductive elements 1370a and 1370b operate as reflective elements in conjunction with the reflector formed by conductive plate 1350 in a manner similar to that described above. The dimensions, including the length and position of the overlap regions 1395, may be adjusted to adjust or tune the operational performance of antenna assembly 1300.

Antenna assembly 1300 includes a printed circuit board 1305 having a square or rectangular shape. In other embodiments, printed circuit board 1305 may have other polygonal shapes, such as an irregular octagon shape following the outline formed by the combination of conductive elements 1365a and 1365b and conductive elements 1370a and 1370b. Further, in some embodiments, conductive plate 1350 may also have different shapes, and may be the same or different from the shape of printed circuit board 1305. It is worth noting that the shape of one or both of printed circuit 1305 and conductive plate 1350 may be adapted to fit manufacturing constraints of the communication device (e.g., electronic assembly 300 in FIG. 3).

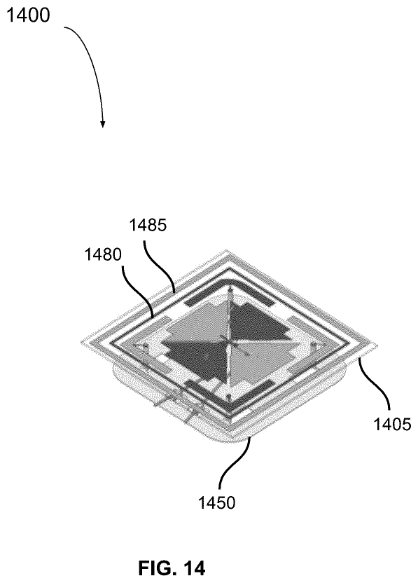

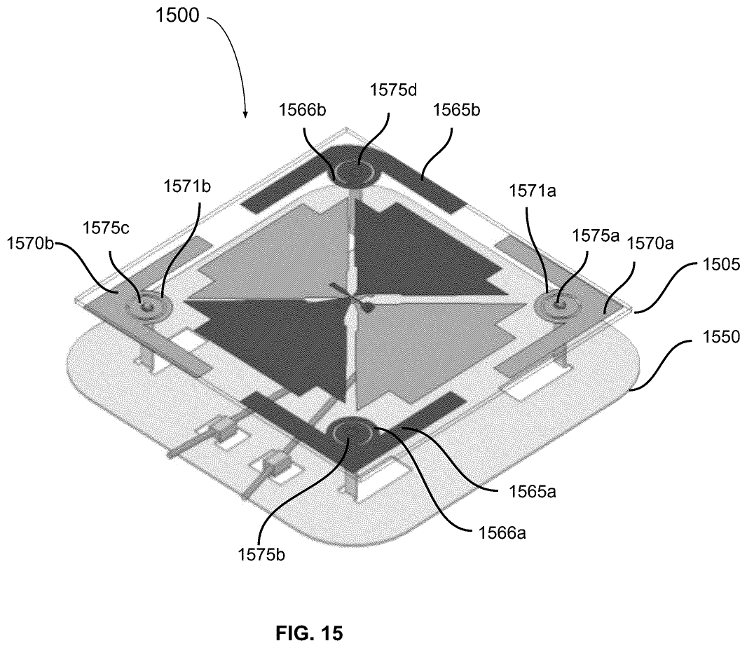

Turning now to FIG. 14, a diagram of another exemplary antenna assembly 1400 according to aspects of the present disclosure is shown. Antenna assembly 1400 may be included as part of an apparatus used for wireless communications, such as communication device 100 described in FIG. 1 or gateway 200 described in FIG. 2. More specifically, antenna assembly 1400 may be used for one or more of antenna assemblies 370, 375 described in FIG. 3. Antenna assembly 1400 may be referred to as a dual-polarized high gain antenna for use over a range of frequencies, or a frequency band, associated with wireless network communications as described above. Except as described below, the structure, orientation, and operation of any elements not described for antenna assembly 1400 are similar to the structure, orientation, and operation of those same elements described for antenna assembly 400 in FIG. 4 above and will not be described in further detail here.

Antenna assembly 1400 includes printed circuit board 1405 mounted at a distance above conductive plate 1450 in a manner similar to that described in FIG. 4. Printed circuit board 1405 is enlarged such that length and width dimensions extend beyond the length and width dimensions of conductive plate 1450. The dimensions of the first and second bow-tie antenna structures and the reflective elements described in FIG. 4 remain the same with respect to the dimensions of conductive plate 1450. Antenna assembly 1400 also includes conductive element 1480 on the top surface of printed circuit board 1405. Conductive element 1480 is shown as a rectangular ring surrounding the reflective elements that further surround the first and second bow-tie antenna structure following the shape of printed circuit board 1405. Antenna assembly 1400 further includes conductive element 1485 on the bottom surface. Conductive element 1485 is shown as a rectangular ring surrounding conductive element 1480 also following the shape of printed circuit board 1400. One or both of conductive elements 1480 and 1485 may be positioned on the portion of printed circuit board 1405 that is outside the dimensions of conductive plate 1450. As shown, conductive elements 1480 and 1485 are not electrically connected to the conductive plate 1450, either directly or through one of the reflective elements. As a result, conductive elements 1480 and 1485 act as parasitic elements that, in conjunction with conductive plate 1450 and the reflective elements, may be used to change or tune the operational performance of antenna assembly 1400 as described above.

It is worth noting that although antenna assembly 1400 describes conductive element 1480 on the top surface and conductive element 1485 on the bottom surface of the printed circuit board, in other embodiments one or both of conductive elements 1480 and 1485 may be on the bottom surface of the printed circuit board. In some embodiments, a conductive element similar to conductive element 1480 or 1485 may be on both the top surface and the bottom surface and may further be electrically connected together through the printed circuit board using one or techniques similar to those described above.

In some embodiments, one or both of conductive elements 1480 and 1485 may be segmented or discontinuous such as in a manner similar to the reflective elements. Further, the dimensions, such as the width, of each of conductive elements 1480 and 1485 are shown as different. In some embodiments, one or more of the dimensions, such as the width, may be the same. Additionally, although antenna assembly 1400 includes two conductive elements 1480 and 1485 operating as parasitic elements, more or fewer conductive elements operating as parasitic elements may be used. Further, in some embodiments, one or more of conductive elements 1480 and 1485 may be electrically connected to one or more of the conductive elements operating as reflective elements or the conductive plate in a manner similar to that described above. For example, conductive elements 1480 and 1485 may be electrically connected to each other and also be electrically connected to the conductive plate through the support mechanism elements. An additional conductive element may also be included on the bottom of the printed circuit board adjacent and below conductive element 1480 and also electrically connected to the conductive plate in a similar manner.

Turning now to FIG. 15, a diagram of another exemplary antenna assembly 1500 according to aspects of the present disclosure is shown. Antenna assembly 1500 may be included as part of an apparatus used for wireless communications, such as communication device 100 described in FIG. 1 or gateway 200 described in FIG. 2. More specifically, antenna assembly 1500 may be used for one or more of antenna assemblies 370, 375 described in FIG. 3. Antenna assembly 1500 may be referred to as a dual-polarized high gain antenna for use over a range of frequencies, or a frequency band, associated with wireless network communications as described above. Except as described below, the structure, orientation, and operation of any elements not described for antenna assembly 1500 are similar to the structure, orientation, and operation of those same elements described for antenna assembly 400 in FIG. 4 above and will not be described in further detail here.

Antenna assembly 1500 includes conductive elements 1565a and 1565b on the top surface of printed circuit board 1505 and conductive elements 1570a and 1570b on the bottom surface of printed circuit board 1505. Conductive elements 1565a and 1565b and conductive elements 1570a and 1570b are each shown as two linear sections similar to those in FIG. 4. Unlike antenna assembly 400 in FIG. 4, each of conductive elements 1565a and 1565b and conductive elements 1570a and 1570b are not directly or electrically connected to connection points 1575a, 1575b, 1575c, and 1575d. Instead, the conductive portion of each of connection points 1575a, 1575b, 1575c, and 1575d is enlarged to form the shape of a circle. Each of conductive elements 1565a and 1565b and conductive elements 1570a and 1570b further include a conductive element 1566a, 1566b, 1571a, and 1571b, respectively. Conductive elements 1566a, 1566b, 1571a, and 1571b are formed in the shape of a portion of an annulus surrounding the portion of the circle shape of connection points 1575a, 1575b, 1575c, and 1575d not adjacent to the conductive elements 1565a and 1565b and conductive elements 1570a and 1570b. Conductive elements 1566a, 1566b, 1571a, and 1571b and conductive elements 1565a, 1565b, 1570a, and 1570b form a capacitive coupling structure with 1575a, 1575b, 1575c, and 1575d, respectively. In this manner, conductive elements 1565a and 1565b and conductive elements 1570a and 1570b are coupled electromagnetically, rather than directly or electrically, to conductive plate 1450 through connection points 1575a, 1575b, 1575c, and 1575d. As a result, antenna assembly 1500 uses conductive elements 1565a, 1565b, 1570a, and 1570b in conjunction with conductive plate, electromagnetically coupled together through a conductive support mechanism, to form an open box reflector or reflective cavity around the first and second bow-tie antenna structures as described above.

It is important to note that the dimensions of connection points 1575a, 1575b, 1575c, and 1575d and the corresponding conductive elements 1566a, 1566b, 1571a, and 1571b may be adjusted or tuned to change the operational performance of antenna assembly 1500 in a manner similar to that described above. In some embodiments, other shapes, such as rectangles or rectangular strips may be used for connection points 1575a, 1575b, 1575c, and 1575d with corresponding conductive element 1566a, 1566b, 1571a, and 1571b surrounding all or a portion of those shapes. Additionally, some or all of connection points 1575a, 1575b, 1575c, and 1575d and/or conductive elements 1566a, 1566b, 1571a, and 1571b may be formed on one or both of the top surface and the bottom surface of the printed circuit board. Further, portions of connection points 1575a, 1575b, 1575c, and 1575d may be formed on the surface of the printed circuit board opposite the surface that includes one or more of conductive elements 1565a and 1565b and conductive elements 1570a and 1570b. The portions of connection points 1575a, 1575b, 1575c, and 1575d on the opposite surface may further overlap portions of one or more of conductive elements 1565a and 1565b and conductive elements 1570a and 1570b.

According to the present disclosure, an antenna assembly is described that includes a printed circuit board having a set of conductive elements forming an antenna structure on at least one surface of the printed circuit board, the printed circuit board further including one or more additional conductive elements partially or fully surrounding the set of conductive elements, and a conductive plate supporting the printed circuit board at a fixed distance from the conductive plate using one or more conductive mechanical support elements. The additional conductive element(s) is/are electrically connected to the conductive plate through one or more of the conductive mechanical support elements.

According to the present disclosure, an apparatus is described that includes a circuit capable of processing a communication signal received wirelessly from a network and/or processing a communication signal for transmission wirelessly to the network. The apparatus further includes an antenna assembly coupled to the circuit. The antenna assembly includes a printed circuit board having a set of conductive elements forming an antenna structure on at least one surface of the printed circuit board, the printed circuit board further including one or more additional conductive elements partially or fully surrounding the set of conductive elements, and a conductive plate supporting the printed circuit board at a fixed distance from the conductive plate using one or more conductive mechanical support elements. The additional conductive element(s) is/are electrically connected to the conductive plate through the one or more of the conductive mechanical support element.

In some embodiments, the apparatus may be a gateway device used to interface a wide area network to a local area network in a customer premises.

In some embodiments, one or more of the additional conductive elements in the antenna assembly may be electrically coupled and/or electromagnetically coupled to the conductive plate through one or more of conductive mechanical support elements.

In some embodiments, one or more of the conductive support elements may be a pin formed out of the conductive plate and oriented orthogonal to the conductive plate and the printed circuit board.

In some embodiments, the conductive plate and one or more of the additional conductive elements may be configured as a three dimensional open reflector structure surrounding the antenna structure, the reflector structure increasing the antenna gain of the antenna structure.

In some embodiments, the antenna structure may be a dual polarized high gain antenna.

In some embodiments, the antenna structure may be formed by conductive elements on both the top surface and the bottom surface of a double-sided printed circuit board. In some embodiments, the conductive elements on the top surface of the double-sided printed circuit board may form a portion of a first bow tie antenna structure and the conductive elements on the bottom surface of the double-sided printed circuit board may form a portion of a second bow tie antenna structure, the conductive elements that form the portion of the second bow tie antenna structure oriented orthogonal to the conductive elements that form the portion of the first bow tie antenna structure.

In some embodiments, at least one of the one or more additional conductive elements may be formed on the top side of the double-sided printed circuit board and at least one of the one or more additional conductive elements may be formed on the bottom surface of the double-sided printed circuit board. In some embodiments, the at least one additional conductive element on the top surface of the double-sided printed circuit board includes a first additional conductive element formed at a first corner of the double-sided printed circuit, the first additional conductive element extending from the first corner and spanning at least a portion of the length of each of the edges of the top surface of the double-sided printed circuit adjacent to the first corner, and a second additional conductive element extending from a second corner opposite the first corner and spanning at least a portion of the length of each of the edges of the top surface of the double-sided printed circuit adjacent to the second corner, and wherein the at least one additional conductive element on the bottom surface of the double-sided printed circuit board includes a third additional conductive element formed at a third corner of the double-sided printed circuit adjacent to the first corner, the third additional conductive element extending from the third corner and spanning at least a portion of the length of each of the edges of the bottom surface of the double-sided printed circuit adjacent to the third corner, and a fourth additional conductive element extending from a fourth corner opposite the third corner and spanning at least a portion of the length of each of the edges of the bottom surface of the double-sided printed circuit adjacent to the fourth corner. In some embodiments, the first additional conductive element and the second additional conductive element span a length that is less than half of the length of each of the edges of top surface of double-sided printed circuit board and wherein the third additional conductive element and the fourth additional conductive element span a length that is less than half of the length of each of the edges of bottom surface of double-sided printed circuit board.

In some embodiments, the antenna assembly may further include one or more coaxial cables coupled to the antenna structure the one or more coaxial cables providing a signal interface between the antenna assembly and a communication circuit, the one or more coaxial cables mechanically coupled to the conductive plate and exiting the antenna assembly in the between the conductive plate and the printed circuit board.

In some embodiments, the antenna structure included in the antenna assembly is configured to transmit and receive wireless signal over a range of frequencies from 3300 megahertz (MHz) to 4200 MHz.

It is to be appreciated that, except where explicitly indicated in the description above, the various features shown and described are interchangeable, that is, a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments of an antenna assembly with directive antenna for use in a communication device, it is noted that modifications and variations can be made by persons skilled in the art in light of the above teachings. It is therefore to be understood that changes may be made in the particular embodiments of the disclosure which are within the scope of the disclosure as outlined by the appended claims.

1. An antenna assembly comprising:
a printed circuit board having a set of conductive elements forming an antenna structure on at least one of a top surface and a bottom surface of the printed circuit board, the printed circuit board further including at least one additional conductive element at least partially surrounding the antenna structure; and
a conductive plate positioned parallel to the bottom surface of the printed circuit board, the conductive plate supporting the printed circuit board at a fixed distance from the conductive plate using at least one conductive mechanical support element;
wherein the at least one additional conductive element is electrically coupled to the conductive plate through the at least one conductive mechanical support element.

2. The antenna assembly of claim 1, wherein the at least one additional conductive element is at least one of electrically coupled and electromagnetically coupled to the conductive plate through the at least one conductive mechanical support element.

3. The antenna assembly of claim 1, wherein the at least one conductive support element is a pin formed out of the conductive plate and oriented orthogonal to the conductive plate and the printed circuit board.

4. The antenna assembly of claim 1, wherein the conductive plate and the at least one additional conductive element are configured as a three dimensional open reflector structure surrounding the antenna structure, the reflector structure increasing the antenna gain of the antenna structure.

5. The antenna assembly of claim 1, wherein the antenna structure is a dual polarized high gain antenna.

6. The antenna assembly of claim 1, wherein the antenna structure is formed by conductive elements on both the top surface and the bottom surface of a double-sided printed circuit board.

7. The antenna assembly of claim 6, wherein the conductive elements on the top surface of the double-sided printed circuit board form a portion of a first bow tie antenna structure and the conductive elements on the bottom surface of the double-sided printed circuit board form a portion of a second bow tie antenna structure, the conductive elements that form the portion of the second bow tie antenna structure oriented orthogonal to the conductive elements that form the portion of the first bow tie antenna structure.

8. The antenna assembly of claim 6, wherein the at least one additional conductive element includes at least one additional conductive element on the top side of the double-sided printed circuit board and at least one additional conductive element on the bottom surface of the double-sided printed circuit board.

9. The antenna assembly of claim 8, wherein the at least one additional conductive element on the top surface of the double-sided printed circuit board includes a first additional conductive element formed at a first corner of the double-sided printed circuit, the first additional conductive element extending from the first corner and spanning at least a portion of the length of each of the edges of the top surface of the double-sided printed circuit adjacent to the first corner, and a second additional conductive element extending from a second corner opposite the first corner and spanning at least a portion of the length of each of the edges of the top surface of the double-sided printed circuit adjacent to the second corner, and wherein the at least one additional conductive element on the bottom surface of the double-sided printed circuit board includes a third additional conductive element formed at a third corner of the double-sided printed circuit adjacent to the first corner, the third additional conductive element extending from the third corner and spanning at least a portion of the length of each of the edges of the bottom surface of the double-sided printed circuit adjacent to the third corner, and a fourth additional conductive element extending from a fourth corner opposite the third corner and spanning at least a portion of the length of each of the edges of the bottom surface of the double-sided printed circuit adjacent to the fourth corner.

10. The antenna assembly of claim 9, wherein the first additional conductive element and the second additional conductive element span a length that is less than half of the length of each of the edges of top surface of double-sided printed circuit board and wherein the third additional conductive element and the fourth additional conductive element span a length that is less than half of the length of each of the edges of bottom surface of double-sided printed circuit board.

11. The antenna assembly of claim 1, further comprising at least one coaxial cable coupled to the antenna structure the at least one coaxial cable providing a signal interface between the antenna assembly and a communication circuit, the at least one coaxial cable mechanically coupled to the conductive plate and exiting the antenna assembly in the between the conductive plate and the printed circuit board.

12. The antenna assembly of claim 1, wherein the antenna structure is configured to transmit and receive wireless signal over a range of frequencies from 3300 megahertz (MHz) to 4200 MHz.

13. An apparatus comprising:
a circuit capable of at least one of processing a communication signal received wirelessly from a network and processing a communication signal for transmission wirelessly to the network; and
an antenna assembly coupled to the circuit, the antenna assembly comprising:
a printed circuit board having a set of conductive elements forming an antenna structure on at least one of a top surface and a bottom surface of the printed circuit board, the printed circuit board further including at least one additional conductive element at least partially surrounding the antenna structure; and
a conductive plate positioned parallel to the bottom surface of the printed circuit board, the conductive plate supporting the printed circuit board at a fixed distance from the conductive plate using at least one conductive mechanical support element;
wherein the at least one additional conductive element is electrically coupled to the conductive plate through the at least one conductive mechanical support element.

14. The antenna assembly of claim 1, wherein the conductive plate and the at least one additional conductive element are configured as a three dimensional open reflector structure surrounding the antenna structure, the reflector structure increasing the antenna gain of the antenna structure.

15. The antenna assembly of claim 1, wherein the antenna structure is formed by conductive elements on both the top surface and the bottom surface of a double-sided printed circuit board.

16. The antenna assembly of claim 15, wherein the conductive elements on the top surface of the double-sided printed circuit board form a portion of a first bow tie antenna structure and the conductive elements on the bottom surface of the double-sided printed circuit board form a portion of a second bow tie antenna structure, the conductive elements that form the portion of the second bow tie antenna structure oriented orthogonal to the conductive elements that form the portion of the first bow tie antenna structure.

17. The antenna assembly of claim 15, wherein the at least one additional conductive element includes at least one additional conductive element on the top side of the double-sided printed circuit board and at least one additional conductive element on the bottom side of the double-sided printed circuit board.

18. The antenna assembly of claim 17, wherein the at least one additional conductive element on the top surface of the double-sided printed circuit board includes a first additional conductive element formed at a first corner of the double-sided printed circuit, the first additional conductive element extending from the first corner and spanning at least a portion of the length of each of the edges of the top surface of the double-sided printed circuit adjacent to the first corner, and a second additional conductive element extending from a second corner opposite the first corner and spanning at least a portion of the length of each of the edges of the top surface of the double-sided printed circuit adjacent to the second corner, and wherein the at least one additional conductive element on the bottom surface of the double-sided printed circuit board includes a third additional conductive element formed at a third corner of the double-sided printed circuit adjacent to the first corner, the third additional conductive element extending from the third corner and spanning at least a portion of the length of each of the edges of the bottom surface of the double-sided printed circuit adjacent to the third corner, and a fourth additional conductive element extending from a fourth corner opposite the third corner and spanning at least a portion of the length of each of the edges of the bottom surface of the double-sided printed circuit adjacent to the fourth corner.

19. The antenna assembly of claim 13, further comprising at least one coaxial cable coupled to the antenna structure the at least one coaxial cable providing a signal interface between the antenna assembly and a communication circuit, the at least one coaxial cable mechanically coupled to the conductive plate and exiting the antenna assembly in the between the conductive plate and the printed circuit board.

20. The apparatus of claim 13, wherein the apparatus is a gateway device used to interface a wide area network to a local area network in a customer premises.
